(19) United States
(12) Patent Application Publication
(10) Pub. No.: US 2024/0359359 A1
(43) Pub. Date: Oct. 31, 2024

(54) METHODS OF PLUGGING A HONEYCOMB BODY AND MASK LAYERS THEREOF

(71) Applicant: CORNING INCORPORATED, CORNING, NY (US)

(72) Inventors: Raymond Victor Ayres, Big Flats, NY (US); Keith Norman Bubb, Beaver Dams, NY (US); Michael George Shultz, Lowman, NY (US); Patrick David Tepesch, CORNING, NY (US); Michael Brian Webb, Lindley, NY (US); Qing Zhou, Shanghai (CN); Cheng-Gang Zhuang, Horseheads, NY (US)

(21) Appl. No.: 18/764,847

(22) Filed: Jul. 5, 2024

Related U.S. Application Data
(63) Continuation of application No. 17/430,386, filed on Aug. 12, 2021.
(60) Provisional application No. 62/805,422, filed on Feb. 14, 2019.

(51) Int. Cl. B28B 11/00; B01D 46/00; B01D 46/24; C04B 38/00

(52) U.S. Cl. CPC B28B 11/007; B01D 46/0001; B01D 46/2418; C04B 38/0012

(57) ABSTRACT

A method of plugging a filter, comprising: positioning a mask layer over the filter comprising a plurality of intersecting walls, wherein the intersecting walls define at least one channel between the intersecting walls; perforating the mask layer proximate the channel to form a hole, wherein the hole extends around a portion of a perimeter of the channel such that the mask layer defines a flap extending over a center of the channel; passing a plugging mixture into the channel through the hole in the mask layer; and sintering the plugging mixture to form a plug within the channel.

This application is a continuation application of U.S. patent application Ser. No. 17/430,386, filed on Aug. 12, 2021, which is a National Stage Application under 35 U.S.C § of International Application No. PCT/US2020/015164, filed on Jan. 27, 2020, which claims the benefit of priority under 35 U.S.C. § 119 of U.S. Provisional Application No. 62/805,422 filed on Feb. 14, 2019, the content of which is incorporated herein by reference in their entireties.

### FIELD OF THE DISCLOSURE

The present disclosure generally relates to honeycomb bodies used as filters, and more specifically, to methods of plugging the honeycomb bodies using a mask layer.

### BACKGROUND

Solid particulate filter bodies, such as diesel particulate filters, may be formed by a matrix of intersecting, thin, porous walls which extend across and between two opposing end faces and form a large number of adjoining hollow passages which extend between end faces of the body. To produce these filters, a laser may be used to make openings in a mask through which a plugging precursor is passed. Known openings in the mask may have circular or square shapes, corresponding to the shape of the hollow passages, and may result in non-uniform placement of plugging precursor within the hollow channels.

### SUMMARY OF THE DISCLOSURE

A method of plugging a filter, comprising: positioning a mask layer over the filter comprising a plurality of intersecting walls, wherein the intersecting walls define at least one channel between the intersecting walls; perforating the mask layer proximate the channel to form a hole, wherein the hole extends around a portion of a perimeter of the channel such that the mask layer defines a flap extending over a center of the channel; passing a plugging mixture into the channel through the hole in the mask layer; and strengthening the plugging mixture to form a plug within the channel.

Also disclosed herein is a method of plugging a filter, comprising: positioning a mask layer over the filter comprising a plurality of intersecting walls, wherein the intersecting walls define at least one channel between the intersecting walls; perforating the mask layer proximate the channel to form a hole, wherein the hole extends along two or more of the intersecting walls such that the mask layer defines a flap extending over a center of the channel; passing a plugging mixture into the channel through the hole in the mask layer; and strengthening the plugging mixture to form a plug within the channel.

Also disclosed herein is a method of plugging a filter, comprising: positioning a mask layer over the filter comprising a plurality of intersecting walls, wherein the intersecting walls define at least one channel between the intersecting walls; perforating the mask layer proximate the channel to form a hole, wherein the hole extends proximate three of the intersecting walls such that the mask layer defines a flap extending over the channel; passing a plugging mixture into the channel through the hole in the mask layer; and strengthening the plugging mixture to form a plug within the channel. The three of the intersecting walls are adjacent to one another.

These and other features, advantages, and objects disclosed herein will be further understood and appreciated by those skilled in the art by reference to the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a perspective view of a filter, according to at least one example;

FIG. 2 is a perspective view of the filter including a plurality of plugs, according to at least one example;

FIG. 3 is a cross-sectional view taken at line III of FIG. 2, according to at least one example;

FIG. 4 is a perspective view of the filter including a mask layer, according to at least one example;

FIG. 5A is an enhanced view taken at section VA of FIG. 4, according to at least one example;

FIG. 5B is an enhanced view taken at section VB of FIG. 4, according to at least one example;

FIG. 5C is an enhanced view taken at section VC of FIG. 4, according to at least one example;

FIG. 5D is an enhanced view taken at section VD of FIG. 4, according to at least one example;

FIG. 5E is an enhanced view taken at section VE of FIG. 4, according to at least one example;

FIG. 5F is an enhanced view taken at section VF of FIG. 4, according to at least one example;

FIG. 5G is an enhanced view taken at section VG of FIG. 4, according to at least one example;

FIG. 6 is a schematic flowchart of a method, according to at least one example;

FIG. 7A is an image of a First Comparative Example;

FIG. 7B is an image of a Second Comparative Example;

FIG. 7C is an image of a Third Comparative Example;

FIG. 7D is an image of a Fourth Comparative Example;

FIG. 8A is an image of a First Example;

FIG. 8B is an image of a Second Example;

FIG. 8C is an image of a Third Example;

FIG. 8D is an image of a Fourth Example;

FIG. 9 is a bar chart of laser burning time for various examples;

FIG. 10 is an image of blockages formed using the First Example and images of polymeric masks used in the formation of the blockages;

FIG. 11A is an image of blockage quality achieved using the Fourth Comparative Example;

FIG. 11B is an image of blockage quality achieved using the First Example;

FIG. 12A is an image of the maximum achievable depth (MAD) of blockages formed using the First Example;

FIG. 12B is an image of the MAD of blockages formed using the Fourth Comparative Example; and

FIGS. 13A-13D are images of blockage depth based on variations of the First Example.

### DETAILED DESCRIPTION

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The construction and arrangement of the elements of the present disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

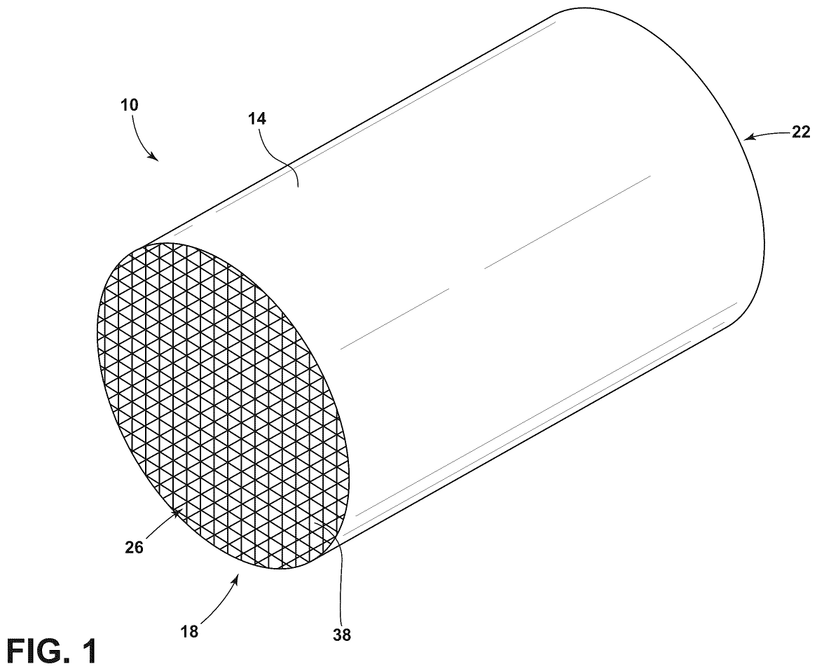

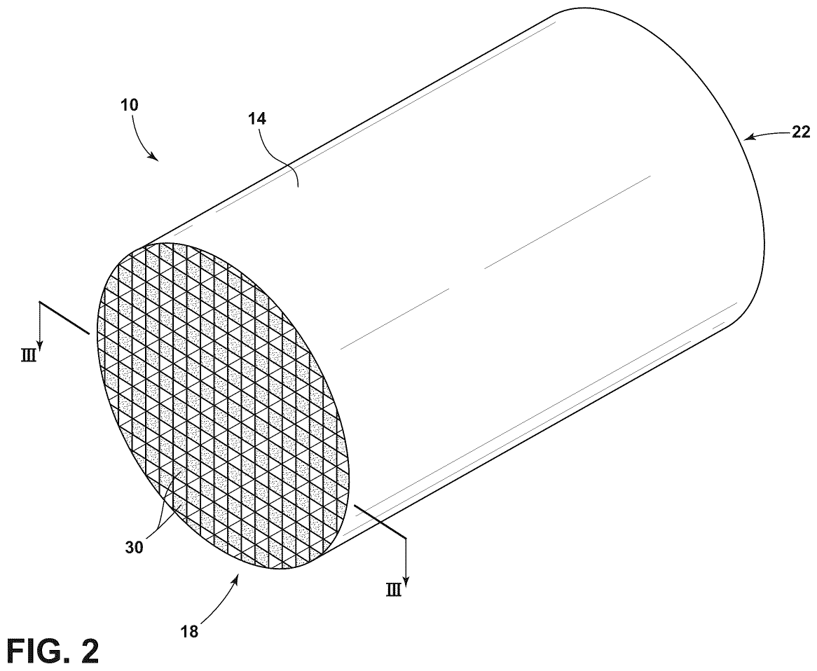

FIGS. 1 and 2 show a filter 10 comprising a honeycomb body 14 comprising a first end 18 and a second end 22. The honeycomb body 14 comprises intersecting walls 38 that form a plurality of channels 26 extending from the first end 18 to the second end 22. According to various examples, the filter 10 comprises a plurality of plugs 30 positioned within at least some of the channels 26, in some embodiments at first and second ends 18, 22, of the honeycomb body 14.

Referring now to FIG. 1, the honeycomb body 14 comprises a matrix of intersecting cell walls 38. According to various examples, the walls 38 may be thin and porous and extend across and between the first and second ends 18, 22 to form a large number of adjoining channels 26. The channels 26 extend between and are open at the first and second ends 18, 22 of the honeycomb body 14. According to various examples, the channels 26 are mutually parallel with one another. The honeycomb body 14 may comprise a transverse cross-sectional channel density of from about 10 channels/in² to about 900 channels/in², or from about 20 channels/in² to about 800 channels/in², or from about 30 channels/in² to about 700 channels/in², or from about 40 channels/in² to about 600 channels/in², or from about 50 channels/in² to about 500 channels/in², or from about 60 channels/in² to about 400 channels/in², or from about 70 channels/in² to about 300 channels/in², or from about 80 channels/in² to about 200 channels/in², or from about 90 channels/in² to about 100 channels/in², or from about 100 channels/in² to about 200 channels/in² or any and all values and ranges therebetween. The walls 38 may have a thickness in mils (i.e., thousands of an inch) of from about 1 mil to about 15 mils, or from about 1 mil to about 14 mils, or from about 1 mil to about 13 mils, or from about 1 mil to about 12 mils, or from about 1 mil to about 11 mils, or from about 1 mil to about 10 mils, or from about 1 mil to about 9 mils, or from about 1 mil to about 8 mils, or from about 1 mil to about 7 mils, or from about 1 mil to about 6 mils, or from about 1 mil to about 5 mils, or from about 1 mil to about 4 mils, or from about 1 mil to about 3 mils, or from about 1 mil to about 2 mils or any and all values and ranges therebetween. It will be understood that although the channels 26 are depicted with a generally square cross-sectional shape, the channels 26 may have a circular, triangular, rectangular, pentagonal or higher order polygon cross-sectional shape without departing from the teachings provided herein.

The honeycomb body 14 may be formed of a variety of materials including ceramics, glass-ceramics, glasses, metals, and by a variety of methods depending upon the material selected. According to various examples, a green body which is transformed into the honeycomb body 14 may be initially fabricated from plastically formable mixture of particles of substances that yield a porous material after being fired. Suitable materials for a green body which is formed into the honeycomb body 14 comprise metallics, ceramics, glass-ceramics, and other ceramic based mixtures. In some embodiments, the honeycomb body 14 is comprised of one or more of the following materials or phases: cordierite (e.g., 2MgO·2Al₂O₃·5SiO₂), aluminum titanate, magnesium dititanate, silicon carbide, magnesium aluminum titanate.

Referring to FIG. 2, the filter 10 can be formed from the honeycomb body 14 by closing or sealing a first subset of channels 26, such as at the first end 18 with plugs 30, and the remaining channels 26 (for example alternating channels 26) being closed at the second end 22 of the honeycomb body 14, using other plugs 30. In operation of the filter 10, fluids such as gases carrying solid particulates are brought under pressure to the inlet face (e.g., the first end 18). The gases then enter the honeycomb body 14 via the channels 26 which have an open end at the first end 18, pass through the walls 38 of the porous cell walls, and out the channels 26 which have an open end at the second end 22. Passing of the gasses through the walls 38 may allow the particulate matter in the gases to remain trapped by the walls 38.

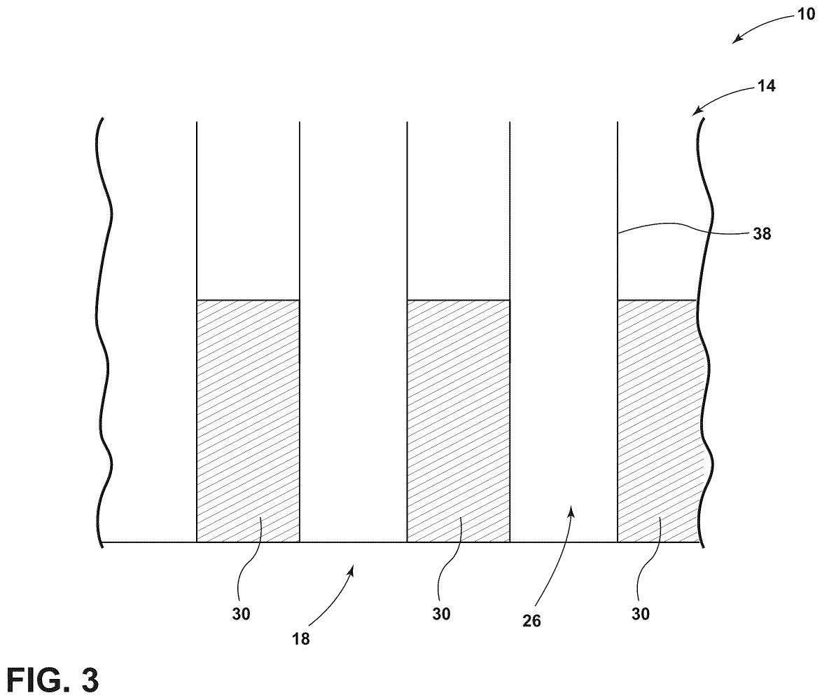

As schematically illustrated in FIGS. 2 and 3, the plugs 30 may be positioned in the channels 26 in an alternating manner. In the depicted example, the plugs 30 are positioned across the first and second ends 18, 22 of the honeycomb body 14 in a “checkerboard” pattern, but it will be understood that other patterns may also be applied. In the checkerboard pattern, each of an open channel's 26 nearest neighbor channels 26 on an end (e.g., either the first or second end 18, 22) includes a plug 30.

The plugs 30 may have an axial length, or longest dimension extending substantially parallel with the channels 26, of about 0.5 mm or greater, of about 1 mm or greater, of about 1.5 mm or greater, of about 2 mm or greater, of about 2.5 mm or greater, of about 3 mm or greater, of about 3.5 mm or greater, of about 4 mm or greater, of about 4.5 mm or greater, of about 5 mm or greater, of about 5.5 mm or greater, of about 6.0 mm or greater, of about 6.5 mm or greater, of about 7.0 mm or greater, of about 7.5 mm or greater, of about 8.0 mm or greater, of about 8.5 mm or greater, of about 9.0 mm or greater, of about 9.5 mm or greater, of about 10.0 mm or greater. For example, the plugs 30 may have an axial length of from about 0.5 mm to about 10 mm, or from about 1 mm to about 9 mm, or from about 1 mm to about 8 mm, or from about 1 mm to about 7 mm, or from about 1 mm to about 6 mm, or from about 1 mm to about 5 mm, or from about 1 mm to about 4 mm, or from about 1 mm to about 3 mm, or from about 1 mm to about 2 mm or any and all value and ranges therebetween. According to various examples, the plurality of plugs 30 located on the first end 18 of the body 14 may have a different length than the plugs 30 positioned on the second end 22 of the body 14.

The variation in length for a plurality of plugs 30 may be expressed as a standard deviation and is calculated as the square root of variance by determining the variation between each length relative to the average length of the plugs 30. The standard deviation of the plurality of plugs 30 is a measure of the variance in the length of plugs 30 positioned, for example, on either the first or second ends 18, 22 of the honeycomb body 14. All of the plurality of plugs 30 on one end (e.g., the first or second end 18, 22) may have a standard deviation in length of from about 0.1 mm to about 3.0 mm. For example, a standard deviation in length of the plugs 30 may be about 3.0 mm or less, about 2.9 mm or less, about 2.8 mm or less, about 2.7 mm or less, about 2.6 mm or less, about 2.5 mm or less, about 2.4 mm or less, about 2.3 mm or less, about 2.2 mm or less, about 2.1 mm or less, about 2.0 mm or less, about 1.9 mm or less, about 1.8 mm or less, about 1.7 mm or less, about 1.6 mm or less, about 1.5 mm or less, about 1.4 mm or less, about 1.3 mm or less, about 1.2 mm or less, about 1.1 mm or less, about 1.0 mm or less, about 0.9 mm or less, about 0.8 mm or less, about 0.7 mm or less, about 0.6 mm or less, about 0.5 mm or less, about 0.4 mm or less, about 0.3 mm or less, about 0.2 mm or less, about 0.1 mm or less or any and all values and ranges therebetween. According to various examples, the plurality of plugs 30 located on the first end 18 of the body 14 may have a different standard deviation than the plugs 30 positioned on the second end 22 of the body 14.

Plugs 30 as inserted into the body 14 may comprise an inorganic binder and a plurality of particles. The inorganic binder may comprise silica, alumina, other inorganic binders and combinations thereof. The silica may be in the form of fine amorphous, nonporous silica particles, in some embodiments preferably generally spherical silica particles. At least one commercial example of suitable colloidal silica for the manufacture of the plugs 30 is produced under the name Ludox®. The inorganic particles of the plugs 30 may be comprised of glass material, ceramic material such as cordierite, glass-ceramic material, and/or combinations thereof. In some embodiments, the inorganic particles may have the same or a similar composition to that of the green body that is used to produce the honeycomb body 14. In some embodiments, the inorganic particles comprise ceramic or ceramic-forming (such as cordierite or cordierite forming) precursor materials which, upon reactive sintering or sintering, form a porous ceramic microstructure.

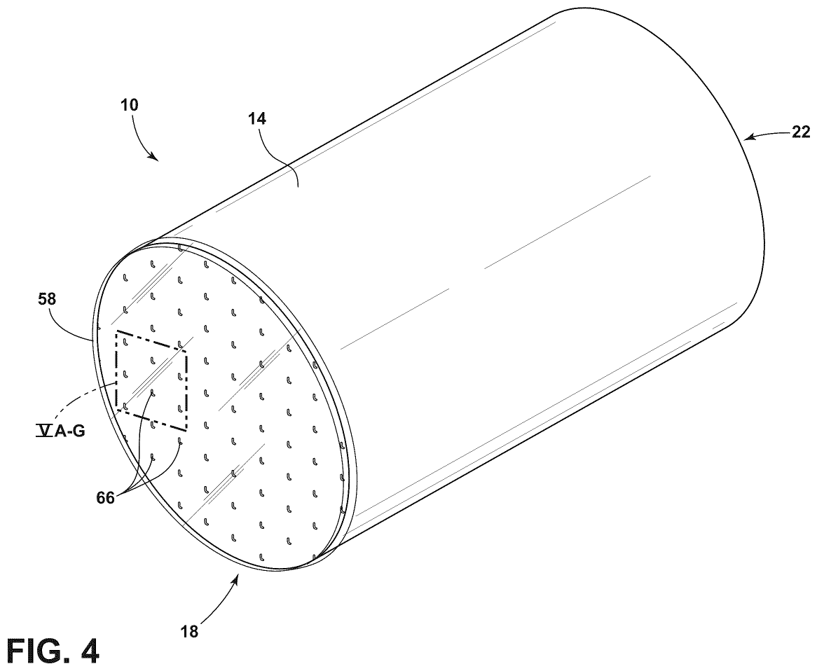

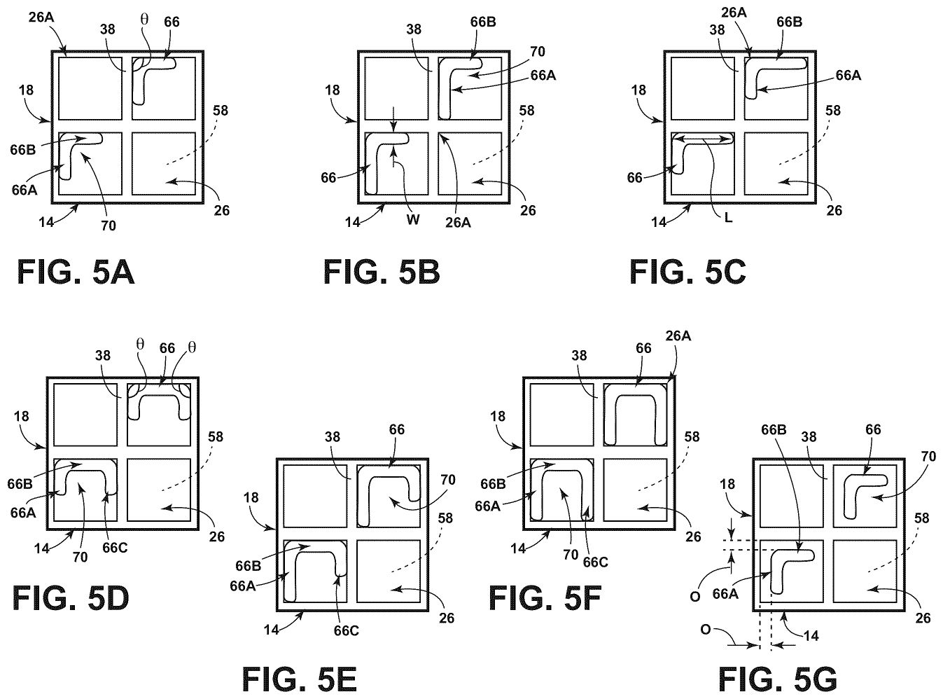

Referring now to FIGS. 4-5G, the filter 10 may be formed using a mask layer 58 across the first end 18 of the honeycomb body 14 to cover the plurality of filter channels 26. The mask layer 58 may be comprised of a metal, a polymeric material, a composite material and/or combinations thereof. For example, the mask layer 58 may be comprised of a rice paper, cellophane, plexiglass, biaxially-oriented polyethylene terephthalate, other materials and/or combinations thereof. The mask layer 58 can be positioned on the first and/or second ends 18, 22 of the honeycomb body 14. The mask layer 58 may cover a portion, a majority, substantially all or all of the first and/or second ends 18, 22. The mask layer 58 may have the same size and shape as the first and/or second ends 18, 22, or the size and/or shape of the mask layer 58 may be different. For example, the mask layer 58 may have the same general shape as a cross-section of the honeycomb body 14 (e.g., generally circular) and may have a greater diameter than the honeycomb body 14 such that the mask layer 58 extends radially outwardly from the honeycomb body 14. The mask layer 58 may extend outwardly from the honeycomb body 14 about 0.5 cm or greater, about 1.0 cm or greater, about 1.5 cm or greater, about 2.0 cm or greater, about 2.5 cm or greater, about 3.0 cm or greater, about 3.5 cm or greater, about 4.0 cm or greater, about 4.5 cm or greater, about 5.0 cm or greater, about 5.5 cm or greater, about 6.0 cm or greater or any and all values and ranges therebetween. The mask layer 58 may be coupled to the honeycomb body 14. For example, the honeycomb body 14 and/or mask layer 58 may have an adhesive adhered thereto, or disposed between, to allow sticking of the mask layer 58 to the honeycomb body 14. In another example, a band may be positioned around an exterior surface of the honeycomb body 14 to retain the mask layer 58 to the honeycomb body 14. According to various examples, the mask layer 58 may define a plurality of holes 66.

The holes 66 may take a variety of shapes and configurations based on a number of different parameters. A first parameter that the holes 66 may be characterized by is how many segments the hole 66 is formed from. According to various examples, the holes 66 may be formed from a first segment 66A, a second segment 66B and a third segment 66C. For example, the hole 66 may be a single segment (e.g., the first segment 66A), two segments (e.g., the first and second segments 66A, 66B) or three segments (e.g., the first, second and third segments 66A, 66B, 66C). In examples where the holes 66 include only the first and second segments 66A, 66B (FIGS. 5A-5C and FIG. 5G), the hole 66 may generally be referred to as having an “L” shape or a “V” shape. In yet other examples, the holes 66 may be composed of the first, second and third segments 66A, 66B, 66C (FIGS. 5D-5F) and may be generally referred to as having a “U” shape. It will be understood that one or more of the holes 66 may be composed of more than three segments without departing from the teachings provided herein.

The various segments of the hole 66 may be positioned in a variety of locations. According to various examples, one or more of the segments may extend along or proximate to one or more of the walls 38. For example, two or more of the segments of the hole 66 may be contiguous with one another and extend along a perimeter of the channel 26 proximate the walls 38. In other words, the hole 66, through the various segments, may trace the perimeter of the channel 26 proximate the walls 38. In the depicted examples, the various segments are shown as connected and contiguous to form a single hole 66, but it will be understood that one or more of the segments may not be connected such that multiple holes 66 are defined in the mask layer 58 over the channel 26.

A second parameter that the holes 66 may be characterized by is the length L of the first, second and/or third segments 66A, 66B, 66C. The length L of one of the individual segments is measured as the longest linear dimension from one end of the segment to the other. In some examples, the length L of each of the first, second and third segments 66A, 66B, 66C may be the same (FIGS. 5A, 5F) or may be different than one another (FIGS. 5B, 5C, 5E). In some examples, two or more of the segments (e.g., the first and third segments 66A, 66C) may have the length L as each other while another segment (e.g., the second segment 66B) has a different length L (FIG. 5D). The length L of one or more of the segments 66A, 66B, 66C may be about 0.2 mm, or about 0.4 mm, or about 0.6 mm, or about 0.8 mm, or about 1.0 mm, or about 1.2 mm, or about 1.4 mm, or about 1.6 mm, or about 1.8 mm, or about 2.0 mm or any and all values and ranges with any of the given values as end points. Put another way, one or more of the segments 66A, 66B, 66C may extend about 5%, or about 10%, or about 15%, or about 20%, or about 25%, or about 30%, or about 35%, or about 40%, or about 45%, or about 50%, or about 55%, or about 60%, or about 65%, or about 70%, or about 75%, or about 80%, or about 85%, or about 90%, or about 95%, or about 99%, or about 100% of a length of the channel 26 or wall 38.

A third parameter that the holes 66 may be characterized by is the width W of the first, second and/or third segments 66A, 66B, 66C. The width W of one of the individual segments is measured as the longest linear dimension from one side of the segment to the other. In some examples, the width W of each of the first, second and third segments 66A, 66B, 66C may be the same or may be different than one another. In some examples, two or more of the segments may have the width W as each other while another segment has a different width W. The width W of one or more of the segments 66A, 66B, 66C may be about 0.01 mm, or about 0.05 mm, or about 0.1 mm or about 0.15 mm, or about 0.20 mm, or about 0.25 mm, or about 0.3 mm, or about 0.35 mm, or about 0.40 mm, or about 0.45 mm, or about 0.5 mm or any and all values and ranges with any of the given values as end points. Put another way, one or more of the segments 66A, 66B, 66C may have a width equal to about 19%, or about 5%, or about 10%, or about 15%, or about 20%, or about 25%, a length of the channel 26 or wall 38.

A fourth parameter that the holes 66 may be characterized by is the angle θ defined between the first, second and/or third segments 66A, 66B, 66C of the hole 66. The angle θ is measured between the outboard sides (i.e., the portions of the hole 66 proximate the nearest wall 38) of the segment at the intersection between two segments. The angle θ may be about 45°, or about 50°, or about 55°, or about 60°, or about 65°, or about 70°, or about 75°, or about 80°, or about 85°, or about 90°, or about 95°, or about 100°, or about 105°, or about 110°, or about 115°, or about 120°, or about 125°, or about 130°, or about 135°, or about 140°, or about 145°, or about 150°, or about 155°, or about 160°, or about 165°, or about 170°, or about 175° or any and all values and ranges between or from the given values.

A fifth parameter that the holes 66 may be characterized by is the offset O of one or more segments from the walls 38. For example one or more of the segments may be positioned away from the intersecting walls 38 (FIG. 5G). The offset O of one or more of the segments 66A, 66B, 66C from the closest wall 38 may be about 0.01 mm, or about 0.05 mm, or about 0.1 mm or about 0.15 mm, or about 0.20 mm, or about 0.25 mm, or about 0.3 mm, or about 0.35 mm, or about 0.40 mm or about 0.45 mm, or about 0.5 mm or any and all values and ranges with any of the given values as end points. It will be understood that the offset O may vary across the length of the segment and that different segments may have different levels of offset O as compared to other segments of the hole 66.

A sixth parameter that the holes 66 may be characterized by is how many corners 26A of the channel 26 the hole 66 is positioned over or proximate. The corners 26A are defined at junctions of adjacent intersecting walls 38. For example, the hole 66 may extend over no corners 26A (FIG. 5G), over one corner 26A (FIG. 5A), over two corners 26A (FIGS. 5B-5D), over three corners 26A (FIG. 5E) or over four corners 26A (FIG. 5F) of the channel 26. It will be understood that a small portion of the mask layer 58 may still extend over part of the corner 26A of the channel 26 due to manufacturing variability and the general shape of the hole 66, but that such an orientation is still considered positioned over the corner 26A.

By tailoring the above noted six different parameters, the hole 66 may take a variety of shapes and configurations. In a first example, the hole 66 may extend over two or more corners 26A defined between the intersecting walls 38 (e.g., FIGS. 5B-5F). In a second example, the hole 66 may extend along two of the intersecting walls 38 with the hole 66 extending substantially equal lengths along each of the two intersecting walls 38 (e.g., FIGS. 5A and 5D). In a third example, the hole 66 does not extend over two or more corners 26A defined between the intersecting walls 38 (e.g., FIGS. 5A-5D and 5G). In a fourth example, the hole 66 extends along two of the intersecting walls 38 and extends different lengths along each of the two intersecting walls 38 (e.g., FIGS. 5B-5E). In a fifth example, the hole 66 does not extend proximate at least one wall 38 of the channel 26 (FIGS. 5A-5G). In a sixth example, the hole 66 extends over one or more corners 26A defined between the intersecting walls 38 (FIGS. 5A-5F). In a seventh example, the hole 66 may generally extend around a portion of a perimeter of the channel 26 (e.g., FIGS. 5A-5G).

It will be understood that any combination of the six parameters highlighted above may be used in any combination with one another, where practicable.

By tailoring the various parameters of the hole 66, the holes 66 may have an area of from about 1% to about 80% of a cross-sectional area of the corresponding respective channel 26 aligned with the hole 66. For example, the holes 66 may have an area of about 80% or less, about 75% or less, about 70% or less, about 65% or less, about 55% or less, about 50% or less, about 45% or less, about 40% or less, about 35% or less, about 30% or less, about 25% or less, about 20% or less, about 15% or less, about 10% or less, about 5% or less of a cross-sectional area of the channel 26 proximate the holes 66. It will be understood that any and all values and ranges therebetween are contemplated.

Use of the above-noted parameters for the designing the holes 66 may result in the formation of a flap 70 of the mask layer 58. According to various examples, the flap 70 may generally extend over a center of the channel 26, but it will be understood that the hole 66 may be formed in such a manner that the flap 70 is not aligned with a center of the channel 26. In some examples, the flap 70 of the mask layer 58 may be anchored to multiple walls 38 (e.g., FIGS. 5A-5E and 5G) or may be anchored to a single wall 38 (e.g., FIG. 5F). As will be explained in greater detail below, the flap 70, being formed of the material of the mask layer 58, is configured to flex or deflect in a direction inward to the filter 10 and into the channel 26. The flexibility of the flap 70 is governed by the thickness and material of the mask layer 58, as well as the geometry of the flap 70. As the flap 70 is, in essence, formed by the segments of the hole 66, the flap 70 may take a variety of shapes including circular, triangular, square, rectangular or higher order polygons.

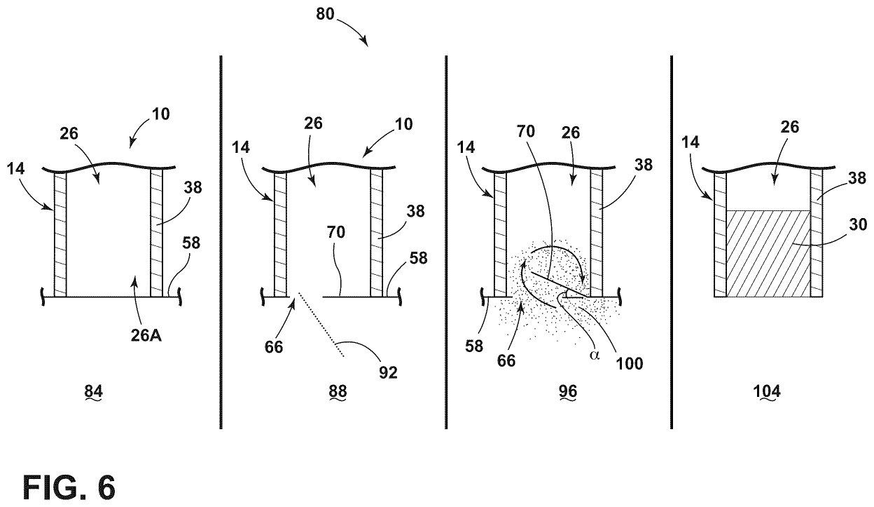

Referring now to FIG. 6, depicted is a schematic method 80 of plugging the filter 10. The method 80 may begin with a step 84 of positioning the mask layer 58 over the filter 10 including the plurality of intersecting walls 38 which define at least one channel 26 between the intersecting walls 38. As explained above, the mask layer 58 may be coupled to the honeycomb body 14 through the use of an adhesive to allow sticking of the mask layer 58 to the honeycomb body 14 and/or through the use of a band positioned around an exterior surface of the honeycomb body 14 to retain the mask layer 58 to the honeycomb body 14.

Next, a step 88 of perforating the mask layer 58 proximate the channel 26 to form the hole 66 is performed. As explained above, by tailoring the various parameters of the hole 66, the mask layer 58 defines the flap 70 extending over the center of the channel 26. Perforating the mask layer 58 to form the hole 66 in the mask layer 58 facilitates fluid communication between the channel 26 and an environment on the other side of the mask layer 58. The hole 66 may be formed through mechanical force (e.g., with a punch) or by utilizing a laser 92. According to various examples, the mask layer 58 may include a plurality of holes 66 positioned across the mask layer 58. For example, the holes 66 may be positioned in a pattern (e.g., a checkerboard-like pattern) across the mask layer 58. In checkerboard-like patterns, the holes 66 are positioned over every other channel 26 at a face (e.g., the first and/or second ends 18, 22). According to various examples, a plurality of holes 66 may be positioned over a plurality of the channels 26. According to various examples, the step 88 of perforating the mask layer 58 to form the plurality of holes 66 across the mask layer 58 may be accomplished in less than about 25 seconds.

Next, a step 96 of passing a plugging mixture 100 into the channel 26 through the hole 66 in the mask layer 58 is performed. In step 96, the honeycomb body 14 and its plurality of channels 26 is brought into contact within the plugging mixture 100 such that a portion of the plugging mixture 100 flows into the filter channels 26. As explained above, the mask layer 58 is disposed on at least one end of the honeycomb body 14. The end of the filter 10 with the mask layer 58 is positioned to contact the plugging mixture 100 such that the plugging mixture 100 flows through the holes 66 and into the channels 26. The honeycomb body 14 may be brought into contact with the plugging mixture 100 inside of a receptacle or in a different container.

The plugging mixture 100 may be composed of a clay, an inorganic binder, water and a plurality of inorganic particles. According to various examples, the plugging mixture 100 may include one or more additives (e.g., rheology modifiers, plasticizers, organic binders, foaming agents, etc.). According to various examples, the clay may include one or more colloidal clays, smectite clays, kaolinite clays, illite clays, and chlorite clays. The inorganic binder may take the form of silica, alumina, other inorganic binders and combinations thereof. The silica may take the form of fine amorphous, nonporous and generally spherical silica particles. The plugging mixture 100 may have sufficient water that the plugging mixture 100 may be viscos or flow.

The honeycomb body 14 may be contacted, submerged, or immersed, to a predetermined depth within the plugging mixture 100. For example, honeycomb body 14 may be submerged to a depth of about 0.5 mm or greater, about 1 mm or greater, about 1.5 mm or greater, about 2 mm or greater, about 2.5 mm or greater, about 3 mm or greater, about 3.5 mm or greater, about 4 mm or greater, about 4.5 mm or greater, about 5 mm or greater, about 5.5 mm or greater, about 6.0 mm or greater, about 6.5 mm or greater, about 7 mm or greater, about 7.5 mm or greater, about 8 mm or greater, about 8.5 mm or greater, about 9 mm or greater, about 9.5 mm or greater, about 1.0 cm or greater, about 2.0 cm or greater, about 3.0 cm or greater, about 4.0 cm or greater, about 5.0 cm or greater, about 6.0 cm or greater or any and all values and ranges therebetween. The honeycomb body 14 may be allowed to contact the plugging mixture 100 under a force. For example, the force at which the honeycomb body 14 contacts the plugging mixture 100 may be less than gravitational force, at gravitational force, or at a force greater than gravity. It will be understood that the force at which the honeycomb body 14 is contacted with the plugging mixture 100 may vary with time.

According to various examples, passing the plugging mixture 100 through the hole 66 and into the channel 26 results in deflection of the flap 70 into the channel 26. For example, as the honeycomb body 14 contacts the plugging mixture 100, the flap 70 of the mask layer 58 is pushed by the plugging mixture 100 into the channel 26. Depending on the material of the mask layer 58, the size and geometry of the flap 70, the pressure the plugging mixture 100 is passed through the hole 66 and other factors, the flap 70 is configured to deflect by an angle α into the channel 26. The angle α is measured as the angle of deflection between the flap 70 and a plane of the mask layer 58. The angle α may be about 1°, or about 2°, or about 4°, or about 6°, or about 8°, or about 10°, or about 12°, or about 14°, or about 16°, or about 20°, or about 22°, or about 24°, or about 26°, or about 28°, or about 30° or any and all values and ranges between the given values. It will be understood that the angle α may change during step 96 depending on process parameters.

The deflection of the flap 70 during step 96 directs the plugging mixture 100 against at least one wall of the channel 26 during passing of the plugging mixture 100 into the channel 26. Without being bound by theory, it is believed that the deflection of the flap 70 into the channel 26 results in the plugging mixture 100 being directed against the intersecting walls 38 of the honeycomb body 14. The contact of the plugging mixture 100 with the walls 38 creates wall drag which results in the plugging mixture 100 fully filling the cross-sectional area of the channel 26 as the plugging mixture 100 moves through the channel 26. The contact of the plugging mixture 100 with the walls 38 results in the close adherence of the plugging mixture 100 with the corners 26A and walls 38 of the channel 26. In conventional masking and plugging systems, slurries passed through openings in a mask often unevenly contact cell surfaces resulting in non-uniformity of the resulting blockages. Use of the flap 70 defined by the mask layer 58 guides the plugging mixture 100 into early contact with the walls 38 such that the plugging mixture 100 enters the channels 26 uniformly and results in the formation of uniform plugs 30.

Use of the flap 70 defined by the mask layer 58 may also affect the maximum achievable depth (MAD) of the plugging mixture 100 and the resulting plugs 30 within the honey bomb body 14. The MAD of the plugging mixture 100 within the honeycomb body 14 is the depth the plugging mixture 100 reaches within the honeycomb body 14 where increasing pressure on the honeycomb body 14 and/or plugging mixture 100 does not increase the depth to which the plugging mixture 100 will move into the channels 26. Without being bound by theory, it is believed that the MAD of the plugging mixture 100 within the honeycomb body 14 is affected by the use of the flap 70 because as the flap 70 directs the plugging mixture 100 against the walls 38 which in turn creates a closer adhesion between the plugging mixture 100 and the walls 38 thereby lowering the MAD of the plugging mixture 100 within the channels 26. For example, the MAD of the plugging mixture 100 within the channels 26 (i.e., which is the same as the length of the plugs 30 plus any differential in drying) may be about 8.5 mm, or about 8.0 mm, or about 7.5 mm, or about 7.0 mm, or about 6.5 mm, or about 6.0 mm, or about 5.5 mm, or about 5.0 mm, or about 4.5 mm, or about 4.0 mm or any and all values and ranges between the given values.

Next, a step 104 of strengthening the plugging mixture 100 to form the plugs 30 within the channels 26 is performed. Once the honeycomb body 14 is disengaged from the plugging mixture 100, the mask layer 58 may be removed and the honeycomb body 14 may be dried and/or heated to strengthen the portion of the plugging mixture 100 remaining in the honeycomb body 14 into the plugs 30. The sintering time and temperature may vary depending on the composition of the plugging mixture 100 as well as other factors. For example, the filter 10 may be sintered at temperatures of from about 800° C. to about 1500° C. For example, the sintering temperature of the filter 10 may be about 800° C., about 900° C., about 1,000° C., about 1,100° C., about 1,200° C., about 1,300° C., about 1,400° C., about 1,500° C., or any and all values and ranges therebetween. In a specific example, sintering the plugging mixture 100 is performed at a temperature of from about 800° C. to about 1500° C.

According to various examples, the honeycomb body 14 may undergo one or more treatments before, during and/or after any of the steps of the method 80. The treatments may help to control the rate of the fluid component migration of the plugging mixture 100 into the porous walls 38 of the honeycomb body 14. Without being bound by theory, the treatments may provide additional mechanisms to govern the overall process and resultant quality of the plugs 30 by controlling the absorption of the liquid of the plugging mixture 100 into the honeycomb body 14. In a first example, the honeycomb body 14 may be exposed to a hydrophobic coating treatment. In such an example, the entrance (e.g., the first or second ends 18, 22) to the channels 26 are exposed to a hydrophobic coating by immersion or spraying, the hydrophobic coating being used to inhibit capillary action that draws fluid from the plugging mixture 100 into the walls 38 of the channels 26. Use of the hydrophobic coating may be used to alter the rate of viscosity change of the plugging mixture 100 as the mixture 100 flows into the channels 26. Otherwise, in some embodiments an untreated filter may absorb a liquid such as water from the plugging mixture 100 which may cause the plugging mixture 74 to undergo water loss upon entering the channels 26, thereby resulting in an undesirable viscosity increase necessitating higher plugging pressure to achieve requisite depths of the plugging mixture 100 in the channels 26. The hydrophobic material may be applied as a coating to a targeted depth into the channel 26 such that once the plugging mixture 100 extends past this point, the rapid increase in viscosity due to water loss advantageously provides for stoppage of the flow of plugging mixture 100 and thereby provides control of the depth of the plugging mixture 100.

Use of the present disclosure may provide a variety of advantages. First, the cycle time for perforating the mask layer 58 may be drastically decreased. In the conventional formation of openings in masks for plugging process, lasers must be rastered over large areas (e.g., the entirety of the opening of the cell) to form sufficiently large openings. Generally, the larger the area being formed, the more independent moves a laser or other perforating mechanism may have to perform. Use of the presently disclosed shapes of the hole 66 may allow for simple and low time investment cut paths to be produced. For example, the “L,” “V” and “U” shapes of the hole 66 may require a fraction of the independent laser cut paths compared to conventional shapes such as a square. Further, as the defining feature of the hole 66 is to form the flap 70, the time typically associated with laser ablating the flap 70 may immediately be saved.

Second, as the cycle time of cutting the holes 66 may be shortened, less capital investment in equipment may be necessary. Conventional formation of openings in polymeric masks often is slow and results in a large number of pieces of equipment being needed to increase production rates. Use of the presently disclosed shapes of the holes 66 may reduce the individual times associated with each hole 66 such that less equipment is needed overall to meet desired production rates leading to less capital investment being necessary. Further, as the presently disclosed shapes of the holes 66 may be relatively simpler, less programming steps for lasers in the perforating step 88 may be needed.

Third, use of the presently disclosed shapes of the hole 66 may decrease the depth variation of the plugs 30. Conventional openings in masks often result in a variety of depths of blockages due to the tendency of plugging slurries to not make contact with walls resulting in blockages with a wide variety of depths. Use of the presently disclosed flap 70 immediately creates wall drag in the plugging mixture 100 resulting in the plugging mixture 100 uniformly filling the channels 26 resulting in uniform depth plugs 30.

Fourth, use of the presently disclosed shapes of the holes 66 may allow for the formation of shorter plugs 30 regardless of the diameter of the channels 26. Conventional bodies having different channel densities often require different process tuning to compensate for the differences in channel density. Use of the present disclosure offers the ability to get shorter depth plugs 30 regardless of the hydraulic diameter of the filter 10 by simply switching the shape of the holes 66. Further, use of the flap 70 affects the MAD of the plugging mixture 100. In conventional processes, gas filters are often pressed into slurries to a depth which is believed will result in blockage formation at a desired depth, but requires large amounts of process turning to achieve. By altering the MAD of the plugging mixture 100, the honeycomb body 14 may be pressed into the plugging mixture 100 to a pressure which produces the MAD such that process turning may be largely eliminated.

Fifth, use of the presently disclosed shapes of the holes 66 and materials of the mask layer 58 offer greater process turning. Conventional plugging processes often can only change between square and circular openings to form different depth blockages. Use of the presently disclosed system offers more independent points of process control for adjusting the depth of the plugs 30 by offering changes to cut pattern, geometry, thickness and stiffness of the material of the mask layer 58.

### EXAMPLES

Provided below are non-limiting examples consistent with the present disclosure and comparative examples.

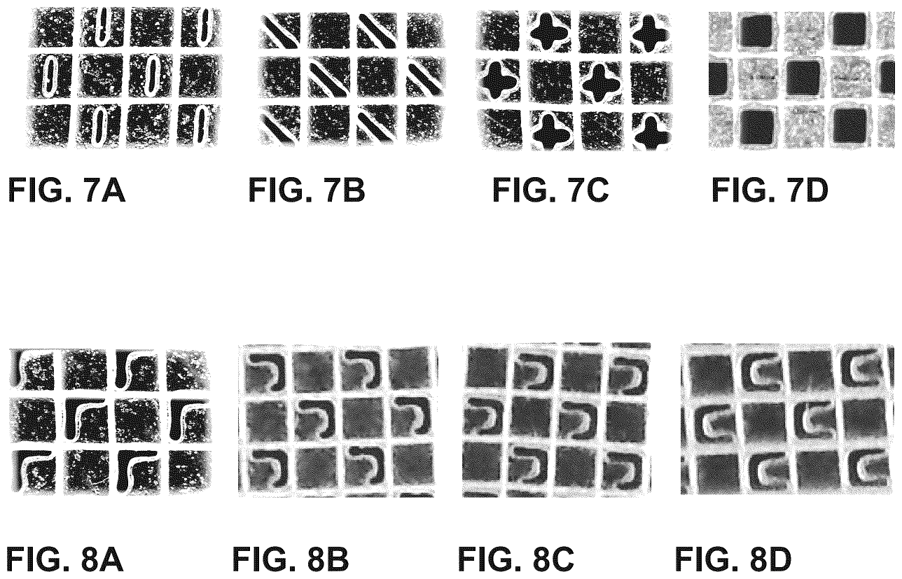

Referring now to FIGS. 7A-7D, provided are images of a variety of comparative examples. A First Comparative Example (FIG. 7A) is a single slash or cut style opening made in a polymeric mask across a center of a cell. The First Comparative Example largely bisects the polymeric mask between partitions of a cell. A Second Comparative Example (FIG. 7B) is a single slash or cut style opening in a polymeric mask diagonally across a center of a cell. The Second Comparative Example largely bisects the polymeric mask between corners formed by partitions of a cell. A Third Comparative Example (FIG. 7C) is a cross style opening in a polymeric mask across a center of a cell. A Fourth Comparative Example (FIG. 7D) is a squared shaped opening in a polymeric mask across the majority a cell.

Referring now to FIGS. 8A-8D, provided are images of a variety of examples consistent with the present disclosure. A First Example (FIG. 8A) is a generally “L” shaped opening (e.g., the hole 66) made in a polymeric mask (e.g., the mask layer 58) and defining a tab (e.g., the flap 70) over a center of a cell (e.g., the channel 26). The opening of the First Example has portions (e.g., the first and second segments 66A, 66B) which extend along partitions (e.g., the walls 38) of the cell and cover three curves (e.g., the corners 26A) of the cell. A Second Example (FIG. 8B) is a generally “U” shaped opening (e.g., the hole 66) made in a polymeric mask (e.g., the mask layer 58) and defining a tab (e.g., the flap 70) over a center of a cell (e.g., the channel 26). The opening of the Second Example has portions (e.g., the first, second and third segments 66A, 66B, 66C) which extend along partitions (e.g., the walls 38) of the cell and cover three curves (e.g., the corners 26A) of the cell. The Second Example has portions which are all of different lengths. A Third Example (FIG. 8C) is a generally “U” shaped opening (e.g., the hole 66) made in a polymeric mask (e.g., the mask layer 58) and defining a tab (e.g., the flap 70) over a center of a cell (e.g., the channel 26). The opening of the Third Example has portions (e.g., the first, second and third segments 66A, 66B, 66C) which extend along partitions (e.g., the walls 38) of the cell and cover three curves (e.g., the corners 26A) of the cell. The Third Example has portions which are all of different lengths. A Fourth Example (FIG. 8D) is a generally “U” shaped opening (e.g., the hole 66) made in a polymeric mask (e.g., the mask layer 58) and defining a tab (e.g., the flap 70) over a center of a cell (e.g., the channel 26). The opening of the Fourth Example has portions (e.g., the first, second and third segments 66A, 66B, 66C) which extend along partitions (e.g., the walls 38) of the cell and cover three curves (e.g., the corners 26A) of the cell. The Fourth Example has portions which are all of substantially the same length.

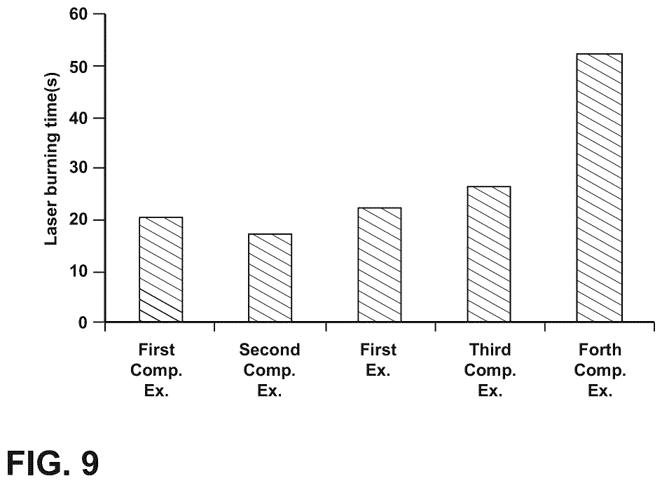

Referring now to FIG. 9, provided is a bar chart of laser burning time (e.g., step 88) vs. various example. The laser burning was performed on a gas particulate filter (e.g., the filter 10) having a 200 cells (e.g., channels 26) per square inch and an 8 mil web (e.g., wall 38) thickness with a diameter of 6.43 inches. As can be seen, use of simplified patterns for the openings (e.g. the holes 66) drastically reduces the cycle time for producing the openings as compared to conventional square designs (i.e., the Fourth Comparative Example). Further, as self-evident from FIG. 9, the First Comparative Example takes roughly less than half the time to form via laser burning as compared to the Fourth Comparative Example.

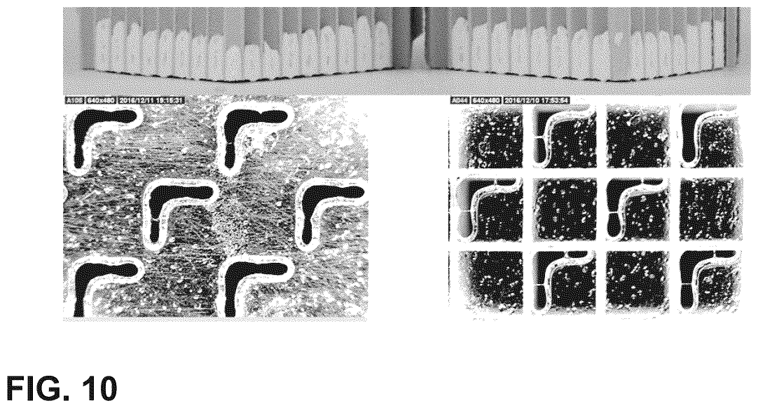

Referring now to FIG. 10, depicted are images of blockages (e.g., the plugs 30) formed using a polymeric mask with the First Example. A grog (e.g., the plugging mixture 100) including Methocel and Ludox paste was utilized. The experiment was conducted on a core drilled gas particulate filter (e.g., the filter 10) having a 200 cells (e.g., channels 26) per square inch and an 8 mil web (e.g., wall 38) thickness with a diameter of 2 inches. The plugging was conducted on an Instron machine with a plugging rate of 0.5 mm/sec. The plugging was automatically ended at 70 psi to reach the MAD of the grog in the gas particulate filter. As can be seen, the formation of random long blockages was mitigated and the depth in the cells (e.g., the channels 26) showed to be uniform at about 5 mm indicating that the “L” shape of the First Example improved plug depth uniformity. The images of the polymeric mask were taken after the plugging process and washing illustrating no damage to the polymeric mask as a result of the plugging process.

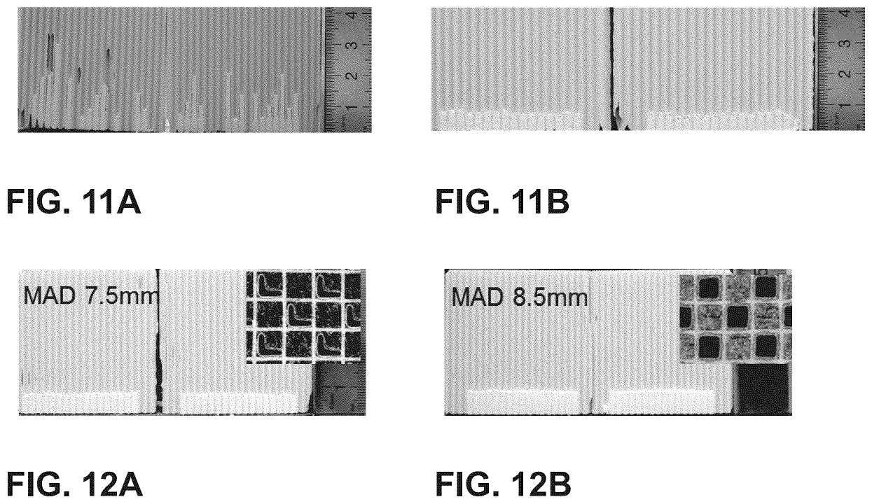

Referring now to FIGS. 11A and 11B, provided are the resulting blockages (e.g., plugs 30) formed using the Fourth Comparative Example (FIG. 11A) and the First Example (FIG. 11B). The experiment was conducted on a core drilled gas particulate filter (e.g., the filter 10) having a 200 cells (e.g., channels 26) per square inch and an 8 mil web (e.g., wall 38) thickness with a diameter of 2 inches. As can be seen, the blockages formed from the Fourth Comparative Example produced a high degree of variability while the First Example facilitated the formation of much more uniform blockages with a shortened MAD of about 5 mm.

Referring now to FIGS. 12A and 12B, provided are the resulting blockages (e.g., plugs 30) formed using the Fourth Comparative Example (FIG. 12A) and the First Example (FIG. 12B). Under the same testing conditions, the First Example facilitated the formation of shorter blockages with a MAD of 7.5 mm as compared to a MAD of 8.5 mm for the Fourth Comparative Example. The experiment was conducted on a core drilled gas particulate filter (e.g., the filter 10) having a 200 cells (e.g., channels 26) per square inch and an 8 mil web (e.g., wall 38) thickness with a diameter of 2 inches.

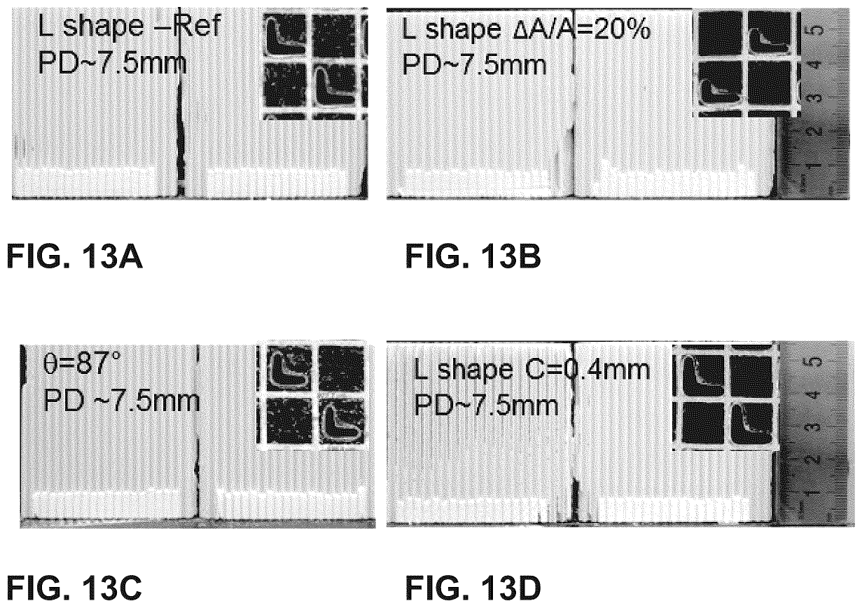

Referring now to FIGS. 13A-13D, provided are variations of the First Example and the resulting blockages (e.g., plugs 30). The experiment was conducted on a core drilled gas particulate filter (e.g., the filter 10) having a 200 cells (e.g., channels 26) per square inch and an 8 mil web (e.g., wall 38) thickness with a diameter of 2 inches. The plugging was conducted on an Instron machine with a plugging rate of 0.5 mm/sec. The plugging was automatically ended at 70 psi such that the MAD of the blockages was reached. The results show that a length decrease of a first portion of the opening (e.g., the first segment 66A of the hole 66) between FIGS. 13A and 13B (denoted AA/A) of 20% had no impact on the plugging performance. A change to the angle between the first portion and a second portion (e.g., the first and second segments 66A, 66B) of the opening (between FIG. 13C) from about 90° (FIG. 13A) to 87° (FIG. 13C) neither showed impact to blockage depth or blockage uniformity. Further, increasing a width of the first and second portions to 0.4 mm (FIG. 13D) did not negatively impact the blockage depth or quality. As such, it is indicated that high tolerance to variation in the shape of the First Example (e.g., due to manufacturing tolerances) may be achieved and that the formation of the tab is beneficial to the formation of the blockages.

What is claimed is:

1. A method of plugging a filter, comprising:
positioning a mask layer over the filter, the filter comprising a plurality of intersecting walls defining at least one channel therebetween;
perforating the mask layer over the at least one channel to form a hole extending proximate a portion of a perimeter of the channel including a first wall of the plurality of intersecting walls;
passing a plugging mixture into the channel through the hole; and
wherein the hole extends around at least one corner of the channel defined at junctions between the intersecting walls and adjacent the first wall, and wherein the hole does not extend along at least another wall of the channel.

2. The method of claim 1, wherein, prior to the passing, coating an entrance of the at least one channel with a hydrophobic coating.

3. The method of claim 1, wherein the perforating forms a flap in the mask layer extending over the channel.

4. The method of claim 3, wherein passing the plugging mixture defects the flap, the deflected flap directing the plugging mixture against the least one wall.

5. The method of claim 1, wherein the hole comprises a first segment extending along an entirety of the first wall and a second segment contiguous with the first segment and extending along a portion of a second wall of the channel adjacent the first wall, and the at least one corner is positioned between the first segment and the second segment.

6. The method of claim 1, wherein the hole comprises a first segment extending along a portion of the first wall and a second segment contiguous with the first segment and extending along a portion of a second wall of the channel adjacent the first wall, and the at least one corner is positioned between the first segment and the second segment.

7. The method of claim 1, wherein the hole comprises a first segment and a second segment contiguous with and orthogonal to the first segment.

8. The method of claim 7, wherein the hole comprises a third segment contiguous with the first segment.

9. The method of claim 8, wherein the third segment is orthogonal with the first segment.

10. A method of plugging a filter, comprising:
positioning a mask layer over the filter, the filter comprising a plurality of intersecting walls defining at least one channel therebetween;
perforating the mask layer proximate the channel to form a hole, the hole extending along at least a portion of at least two of the intersecting walls defining the channel, and wherein the hole does not extend along at least another wall of the channel; and
passing a plugging mixture into the channel through the hole in the mask layer.

11. The method of claim 10, wherein the hole comprises a first segment extending proximate a first intersecting wall of the plurality of intersecting walls and a second segment contiguous with the first segment and extending proximate a second intersecting wall of the plurality of intersecting walls.

12. The method of claim 11, wherein the second segment is orthogonal to the first segment.

13. The method of claim 12, wherein the hole comprises a third segment contiguous with and orthogonal to the first segment, parallel with the second segment, and extending proximate a third intersecting wall of the plurality of intersecting walls.

14. The method of claim 13, wherein a length of at least one of the second segment or the third segment is less than a length of the first segment.

15. The method of claim 10, wherein the hole is offset from the at least two intersecting walls by an offset distance in a range from about 0.1 mm to about 0.5 mm.
